(19) United States
(12) Patent Application Publication
(10) Pub. No.: US 2026/0171537 A1
(43) Pub. Date: Jun. 18, 2026

(54) ENERGY STORAGE DEVICE

(71) Applicant: TOYOTA JIDOSHA KABUSHIKI KAISHA, Toyota-shi (JP)

(72) Inventor: Akihiro TSUZUKI, Toyota-shi (JP)

(73) Assignee: TOYOTA JIDOSHA KABUSHIKI KAISHA, Toyota-shi (JP)

(21) Appl. No.: 19/290,981

(22) Filed: Aug. 5, 2025

(30) Foreign Application Priority Data
Dec. 13, 2024 (JP) 2024-219367

(51) Int. Cl. H01M 10/6551; H01M 10/613; H01M 50/204; H01M 50/503

(52) U.S. Cl. CPC H01M 10/6551; H01M 10/613; H01M 50/204; H01M 50/503

(57) ABSTRACT

An energy storage device is configured by stacking an electrically conductive current collector plate, a plurality of battery modules each including one or more battery cells, and a cooler configured to cool the battery modules. A groove is provided on a surface of the current collector plate that faces the battery module.

### CROSS-REFERENCE TO RELATED APPLICATION

This application claims priority to Japanese Patent Application No. 2024-219367 filed on Dec. 13, 2024. The disclosure of the above-identified application, including the specification, drawings, and claims, is incorporated by reference herein in its entirety.

### BACKGROUND

### 1. Technical Field

The technique of the present disclosure relates to energy storage devices.

### 2. Description of Related Art

In addition to being used in small portable devices such as mobile phones and laptop computers, energy storage devices have recently seen increasing demand for use in vehicles such as battery electric vehicles (BEVs) and hybrid electric vehicles (HEVs).

For example, Japanese Unexamined Patent Application Publication No. 2023-177537 (JP 2023-177537 A) discloses an energy storage device including: a cooler disposed between adjacent energy storage modules; a first current collector plate stacked on one side of the energy storage modules; and a second current collector plate stacked on the other side of the battery modules.

### SUMMARY

Reliable cooling of battery modules (energy storage modules) used in an energy storage device contributes to maintaining the performance of the energy storage device over an extended period. However, there remains room for improvement in terms of the cooling performance of such energy storage devices.

The present disclosure has been made in view of the above-described issues, and an object thereof is to provide an energy storage device capable of effectively cooling battery modules.

In order to achieve the above object, an energy storage device of claim 1 is configured by stacking a current collector plate that is electrically conductive, a plurality of battery modules each including one or more battery cells, and a cooler configured to cool the battery modules. A groove is provided on a surface of the current collector plate that faces the battery module.

In the energy storage device of claim 1, heat generated in the battery modules can be released into the grooves, which can improve the cooling performance of the energy storage device.

According to an energy storage device of claim 2, in the energy storage device of claim 1, at least one end of the groove extends to an outer edge of the current collector plate.

In the energy storage device of claim 2, the heat released into the groove can be smoothly dissipated to the outside of the current collector plate.

According to an energy storage device of claim 3, in the energy storage device of claim 1 or 2, a plurality of the grooves is provided so as to extend across the surface of the current collector plate that faces the battery module.

In the energy storage device of claim 3, the heat released into the groove can be more smoothly dissipated to the outside of the current collector plate.

According to an energy storage device of claim 4, in the energy storage device of any one of claims 1 to 3, the energy storage device further includes an electrical connection plate that is electrically conductive. The electrical connection plate is disposed between the battery modules.

In the energy storage device of claim 4, the cooler can be efficiently arranged.

According to the energy storage device described above, the battery modules can be efficiently cooled.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view illustrating an example of an energy storage device according to an embodiment of the present disclosure;

FIG. 2 is a perspective view illustrating an example of a current collector plate included in the energy storage device shown in FIG. 1;

FIG. 3 shows an example of a surface of the current collector plate in FIG. 2 that faces a battery module;

FIG. 4 is a schematic front view of a portion of an energy storage unit shown in FIG. 1; and

FIG. 5 is a cross-sectional view taken along line A-A in FIG. 4.

### DETAILED DESCRIPTION OF EMBODIMENTS

Embodiments for carrying out the present disclosure will be described below with reference to the drawings. The following description schematically illustrates the scope necessary to achieve the objectives of the present disclosure and primarily focuses on the relevant portions necessary for explanation, while omitting descriptions of portions based on known techniques. Identical or corresponding components in the drawings are denoted by the same or similar signs, and redundant descriptions will be omitted. When multiple identical or corresponding components are included in the drawings, only some of them may be labeled with signs for simplicity of the drawings.

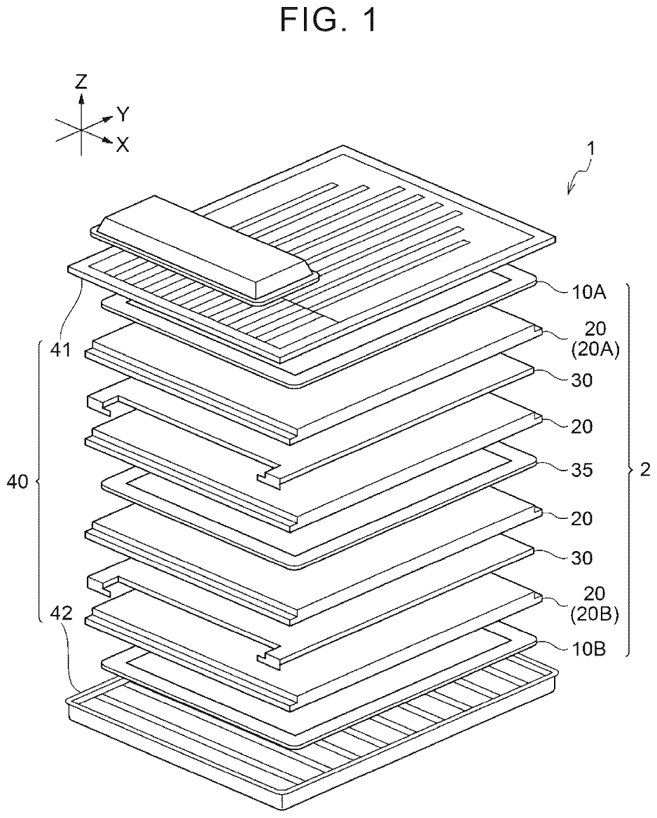

FIG. 1 is an exploded perspective view illustrating an example of an energy storage device according to an embodiment of the present disclosure. An energy storage device 1 according to the present embodiment is exemplified below as an energy storage device mounted in a vehicle such as a battery electric vehicle (BEV) or a hybrid electric vehicle (HEV). In the following description, the direction indicated by arrow X is defined as the left-right direction, arrow Y as the front-rear direction, and arrow Z as the up-down direction.

As shown in FIG. 1, the energy storage device 1 includes at least an energy storage unit 2 that includes a pair of current collector plates 10A, 10B, a plurality of battery modules 20, and a cooler 30. The energy storage unit 2 may be formed by stacking the battery modules 20 and the cooler 30 with the cooler 30 disposed between the battery modules 20 and then sandwiching the resulting stack between the current collector plates 10A, 10B.

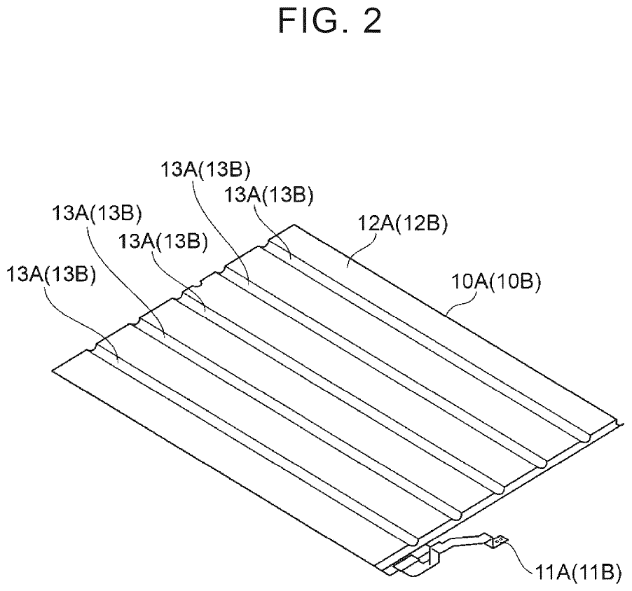

The current collector plates 10A, 10B may include two current collector plates 10A, 10B configured as plate-shaped members made of an electrically conductive material. Of the current collector plates 10A, 10B, one current collector plate (hereinafter referred to as “first current collector plate”) 10A may be stacked on the top of the uppermost battery module 20A in the stacking direction of the battery modules 20 (e.g., the up-down direction) (hereinafter, this battery module may be referred to as “first battery module”). The other current collector plate (hereinafter referred to as “second current collector plate”) 10B may be stacked on the bottom of the lowermost battery module 20B in the up-down direction (hereinafter, this battery module may be referred to as “second battery module”). For example, the first current collector plate 10A may be a current collector plate for a cathode, and the second current collector plate 10B may be a current collector plate for an anode. In this regard, the first current collector plate 10A may be connected to a cathode terminal 11A (see FIG. 2), and the second current collector plate 10B may be connected to an anode terminal 11B (see FIG. 2).

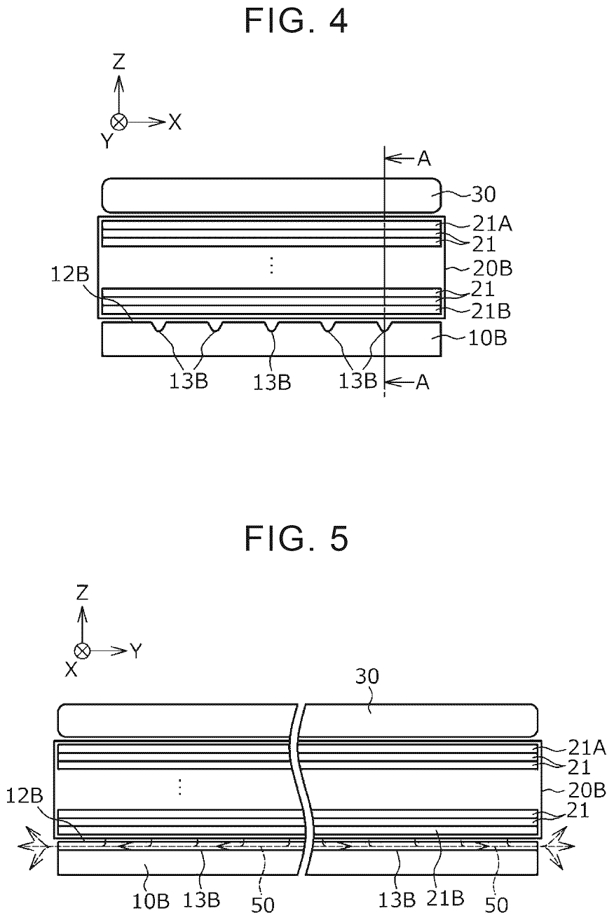

The battery modules 20 are arranged in a predetermined first direction, for example, the up-down direction. The battery modules 20 may be configured as secondary batteries having a substantially rectangular parallelepiped shape, and each may include a plurality of battery cells 21 (see FIG. 4) therein. The battery modules 20 of the present embodiment may be configured as so-called bipolar batteries. More specifically, the battery modules 20 may be, for example, laminate-type aqueous lithium-ion batteries or nickel metal hydride batteries. The battery modules 20 are not limited to the bipolar batteries, and may be, for example, all-solid-state batteries or capacitors.

The cooler 30 may be configured as a substantially plate-shaped member whose dimensions in the left-right direction and the front-rear direction are adjusted to be approximately the same as those of the battery modules 20. The cooler 30 is disposed between adjacent battery modules 20. The cooler 30 may be formed using a highly thermally conductive material, and may be provided with an internal coolant channel (not shown) through which a coolant can flow. The specific cooling structure of the cooler 30 is not limited to the example described above, and any configuration may be adopted as long as it provides a cooling function.

A cooler 30 may not be provided between every pair of adjacent battery modules 20 in the energy storage unit 2. Specifically, in the energy storage unit 2 of the present embodiment, an electrical connection plate 35 may be disposed between two battery modules 20 located in the middle in the up-down direction, in place of a cooler 30.

The electrical connection plate 35 may be configured as an electrically conductive plate-shaped member capable of electrically connecting adjacent battery modules 20. It is preferable to use a highly thermally conductive material for the electrical connection plate 35, as the electrical connection plate 35 made of such a material does not interfere with the cooling effect provided by the cooler 30. By appropriately positioning the electrical connection plate 35, the number of coolers 30 used in a single energy storage device 1 can be adjusted, which can reduce the manufacturing cost of the energy storage device 1. A cooler 30 may be disposed in place of the electrical connection plate 35, or the electrical connection plate 35 may be omitted.

The energy storage unit 2 including the configuration described above may be housed in a case 40. The case 40 may include at least a top plate 41 and a bottom plate 42.

The top plate 41 may cover the top of the first current collector plate 10A. The bottom plate 42 may cover the bottom of the second current collector plate 10B. A side wall covering the side surfaces of the energy storage unit 2 may be provided to stand along the outer periphery of the bottom plate 42. An insulating sheet and an elastic sheet (both not shown) may also be interposed between the top plate 41 and the first current collector plate 10A and between the bottom plate 42 and the second current collector plate 10B, respectively.

In the energy storage unit 2, each of the first battery module 20A and the second battery module 20B is configured such that the cooler 30 is disposed on one surface thereof and the first or second current collector plate 10A, 10B is disposed on the other surface. In this case, since the cooler 30 is not provided on the other surface of each of the first and second battery modules 20A, 20B, the function to cool the battery module 20 is lower on the other surface compared to the one surface on which the cooler 30 is provided. As a result, in each of the first and second battery modules 20A, 20B, a temperature difference may occur between the battery cells 21 adjacent to the one surface (specifically, a first battery cell 21A described later, etc.) and the battery cells 21 adjacent to the other surface (specifically, a second battery cell 21B described later, etc.). When such a temperature difference occurs, some insufficiently cooled battery cells may degrade more rapidly than other cells. This may shorten the service life of the battery module 20 or the entire energy storage device 1 compared to a case in which such a temperature difference does not occur. Therefore, in order to reduce such a temperature difference and suppress non-uniform cooling in the battery modules 20, the present embodiment adopts a structure for enhancing the cooling performance for the current collector plates 10A, 10B. The structure of the current collector plates 10A, 10B will be described in further detail below.

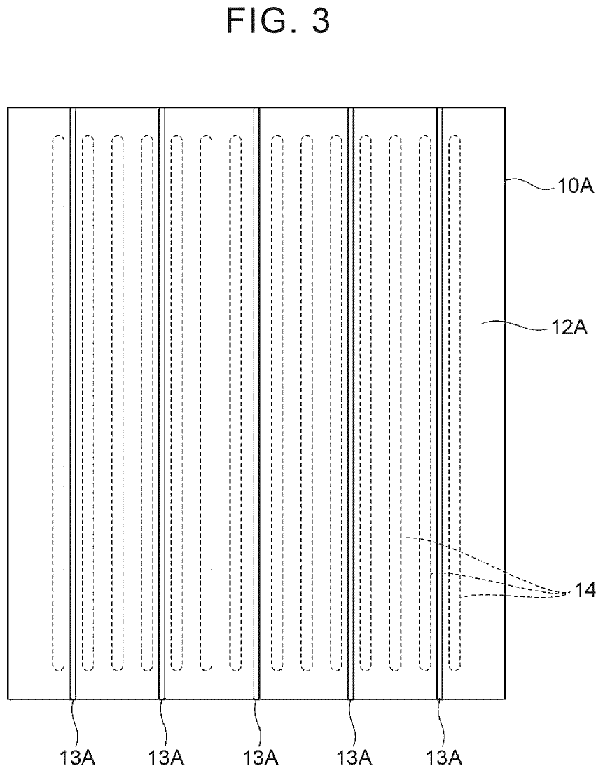

FIG. 2 is a perspective view illustrating an example of a current collector plate included in the energy storage device shown in FIG. 1. FIG. 3 schematically illustrates an example of a surface of the current collector plate in FIG. 2 that faces a battery module. The current collector plates 10A, 10B in the present embodiment may have the same configuration except for their arrangement and polarity. Therefore, the first current collector plate 10A will be described by way of example with reference to FIGS. 2 and 3. Reference signs corresponding to the second current collector plate 10B are shown in parentheses in these figures, and substantially the same description applies to the second current collector plate 10B.

As shown in FIG. 2, the first current collector plate 10A of the energy storage device 1 according to the present embodiment is configured as a plate-shaped electrically conductive member, and the cathode terminal 11A is provided at one end of the first current collector plate 10A. A surface of the first current collector plate 10A that faces the battery module 20, more specifically, the first battery module 20A (hereinafter, this surface will be referred to as “module-facing surface” 12A) is provided with a groove 13A.

The groove 13A forms a passage capable of receiving heat released from the upper portion of the first battery module 20A toward the first current collector plate 10A. Preferably, at least one end of the groove 13A extends to the outer edge of the first current collector plate 10A so as to allow heat received from the first battery module 20A to be dissipated to the outside of the first current collector plate 10A. The number of grooves 13A and the width and extending direction thereof can be adjusted as appropriate as long as the function described above can be maintained. As shown in FIG. 3, in the present embodiment, the first current collector plate 10A is exemplified as having a plurality of (e.g., five) substantially parallel grooves 13A that extends linearly in the front-rear direction across the module-facing surface 12A from the front end to the rear end of the module-facing surface 12A. It is preferable to configure the grooves 13A in the manner described above, as this allows the heat received from the first battery module 20A to be smoothly dissipated from both ends of the grooves 13A to the outside of the first current collector plate 10A. The grooves 13A may have any configuration as long as they are capable of receiving heat. The ends of the grooves 13A may not necessarily reach the outer edge of the first current collector plate 10A, as in the above example. The cross-sectional shape of the grooves 13A is also not particularly limited, and may be, for example, substantially triangular, rectangular, trapezoidal, or semicircular. FIG. 4 illustrates, as an example, grooves 13B having a substantially triangular cross-section.

As shown in FIG. 3, it is preferable that the grooves 13A be positioned so as not to overlap an adhesive application region 14 to which an adhesive is applied for bonding the first current collector plate 10A to the first battery module 20A. With the grooves 13A being arranged so as not to overlap the adhesive application region 14, the adhesive is less likely to flow into the grooves 13A and partially clog them. For example, as shown in FIG. 3, substantially aligning the extending direction of the grooves 13A with that of the adhesive application region 14 ensures reliable bonding between the first current collector plate 10A and the first battery module 20A, while also maintaining the heat-dissipating function of the grooves 13A. An electrically conductive adhesive is preferably used as the adhesive applied to the adhesive application region 14.

FIG. 4 is a schematic front view of a portion of the energy storage unit shown in FIG. 1. FIG. 4 shows part of the energy storage unit 2. Specifically, only the second current collector plate 10B, the second battery module 20B, and the cooler 30 disposed on the top of the second battery module 20B are shown in an enlarged view. The second battery module 20B shown in FIG. 4 is configured by stacking, for example, a plurality of (e.g., 30) plate-shaped battery cells 21. In the second battery module 20B, if no grooves 13B are provided in the second current collector plate 10B, the battery cell (second battery cell) 21B located adjacent to the second current collector plate 10B and its surrounding battery cells 21 tend to be cooled less effectively than the other battery cells such as the battery cell (first battery cell) 21A located adjacent to the cooler 30 and its surrounding cells 21. As a result, a significant temperature difference may occur among the thirty battery cells 21. Therefore, in the present embodiment, a plurality of grooves 13B is formed in a module-facing surface 12B of the second current collector plate 10B to improve the cooling performance for the second battery cell 21B and its surrounding battery cells 21, thereby reducing the occurrence of temperature differences among the battery cells 21 within the second battery module 20B.

FIG. 5 is a cross-sectional view taken along line A-A in FIG. 4. When charging or discharging of the energy storage unit 2 of the present embodiment begins, heat is generated from each battery cell 21 within the second battery module 20B. At this time, the heat generated by the battery cells 21 adjacent to the cooler 30 such as the first battery cell 21A is dissipated via the cooler 30. On the other hand, as shown in FIG. 5, heat 50 generated in the battery cells 21 adjacent to the second current collector plate 10B such as the second battery cell 21B is dissipated to the outside of the energy storage unit 2 through the grooves 13B formed in the second current collector plate 10B. By adopting a configuration that allows the heat 50 released from the battery cells 21 adjacent to the second current collector plate 10B, including the second battery cell 21B, to be dissipated to the outside via the grooves 13B, insufficient cooling of the second battery cells 21B can be reduced. As a result, temperature differences among the battery cells 21 are less likely to occur.

As described above, in the energy storage device of the present embodiment, the battery modules included in the energy storage device can be effectively cooled, thereby reducing adverse effects on the service life of the battery modules or the energy storage device due to progressive local degradation of the battery cells.

The present disclosure is not limited to the embodiment described above, and various modifications may be made without departing from the spirit and scope of the present disclosure. All such modifications are encompassed within the technical scope of the present disclosure. For each component of the present disclosure, the number of components is not limited to one, and there may be two or more components, unless otherwise specified in the specification.

What is claimed is:

1. An energy storage device, wherein the energy storage device is configured by stacking a current collector plate that is electrically conductive, a plurality of battery modules each including one or more battery cells, and a cooler configured to cool the battery modules and a groove is provided on a surface of the current collector plate that faces the battery module.

2. The energy storage device according to claim 1, wherein at least one end of the groove extends to an outer edge of the current collector plate.

3. The energy storage device according to claim 1, wherein a plurality of the grooves is provided so as to extend across the surface of the current collector plate that faces the battery module.

4. The energy storage device according to claim 1, further comprising an electrical connection plate that is electrically conductive, the electrical connection plate being disposed between the battery modules.
